(19) United States
(12) Patent Application Publication
(10) Pub. No.: US 2011/0238932 A1
(43) Pub. Date: Sep. 29, 2011

(54) CONTROLLER AND METHOD FOR OPERATING A CONTROLLER, COMPUTER PROGRAM, COMPUTER PROGRAM PRODUCT

(76) Inventors: Gunther Reimann, Winnenden (DE); Steffen Hald, Schwaikheim (DE); Martin Hilliges, Deckenpfronn (DE); Hauke Wendt, Ditzingen (DE); Rocco Gonzalez Vaz, Stuttgart (DE)

(21) Appl. No.: 13/121,642

(22) PCT Filed: Aug. 28, 2009
(86) PCT No.: PCT/EP2009/061156

§ 371 Date: Jun. 8, 2011

(30) Foreign Application Priority Data
Sep. 29, 2008 (DE) 10 2008 042 445.5

(51) Int. Cl. G06F 12/00

(52) U.S. Cl. 711/154; 711/E12.001

(57) ABSTRACT

In a controller, a method for operating a controller, a computer program, and a computer program product, data are saved in a memory, a setpoint is defined, an actual value is identified, the actual value is compared with the setpoint, and the data is saved as a function of the comparison result.

### FIELD OF THE INVENTION

The present invention relates to a controller, a method, and a computer program or computer program product.

### BACKGROUND INFORMATION

In the automotive sector, controllers save data in a nonvolatile memory, for example before they are switched off. The controllers are, for example, switched off when a driver of a motor vehicle switches off the motor vehicle.

The maximum number of write access to a data memory provided for saving the data of the controller is typically limited, as a consequence of the design, to a specific maximum value. Once that maximum value is exceeded, there is no guarantee that the data can be correctly saved in the memory. This means that data read out of the memory, for operation of the controller or for diagnosis of the controller, may be erroneous.

The controllers typically read data out of the memory at the beginning of an operating cycle. It is therefore necessary to ensure that, for correct operation of the controller, these data are error-free. For this reason, memories which ensure that the maximum possible number of write accesses to the memory is greater than, for example, a vehicle service life specified by a manufacturer of the motor vehicle, are typically used.

### SUMMARY

The controller, method, computer program and computer program product according to example embodiments of the present invention have, in contrast thereto, the advantage that on the one hand fewer write accesses occur with respect to a service life of a controller, so that more inexpensive memories having a lower maximum number of write accesses can be used. On the other hand, the service life of the controller with reference to the memory being used is increased, since fewer write accesses to the memory occur than with conventional controllers.

Particularly advantageously, data saving at the end of an operating cycle is to be delayed, and the controller is to be left switched on in extended fashion for a defined time period. The goal is to wait long enough that the ignition on the vehicle is switched back on. For this purpose, what is selected as a setpoint is a defined time period which is greater than, for example the usual shutdown time of a motor vehicle used for delivery operations, or of an electrical device that is often switched off for short periods. Data saving thus becomes superfluous in this case, since a new operating cycle of the controller is not present.

It is particularly advantageous to adapt the setpoint variably to a frequency of write operations per operating unit of the controller. If multiple controllers of the same design are used, the setpoint is thus adapted to the individual behavior of the various users of the controllers.

It is particularly advantageous to increase the setpoint by a first defined value if the frequency of write operations per operating unit of the controller exceeds a first defined threshold value. The result is that the setpoint is corrected in particularly simple fashion until the waiting time prior to saving of the data in the controller is long enough to avoid excessively frequent saving.

It is particularly advantageous to decrease the setpoint by a second defined value. The result is that the correction of the defined time period is not cancelled until the frequency of write operations per operating unit of the controller drops below the first defined threshold value.

It is particularly advantageous to decrease the setpoint by a second defined value as long as the setpoint is greater than a second defined threshold value. This prevents the setpoint for the waiting time from becoming lower than a specific value, for example zero.

It is particularly advantageous to identify the frequency of write operations per operating unit of the controller as a function of a current total mileage of a motor vehicle, or of a current number of operating hours of the controller and an accumulated number of memory accesses to the memory. The frequency of write operations per operating unit of the controller thereby represents a very accurate indicator of the individual utilization of the respective controller.

It is particularly advantageous if the setpoint does not exceed a third defined value. This imposes an upward limit on the waiting time until saving, thus ensuring that the data are saved after that maximum waiting time has elapsed.

It is particularly advantageous to switch off the controller as soon as the data have been saved. The energy consumption of the controller is thereby reduced, thus decreasing the load on, for example, a battery that is used to supply energy to the controller.

Exemplifying embodiments of the present invention are depicted in the drawings and further explained in the description that follows. In the drawings:

### BRIEF DESCRIPTION OF THE DRAWINGS

FIG. 1 schematically depicts a controller according to an example embodiment of the present invention,

FIG. 2 is a flow chart of an embodiment of the method according to an example embodiment of the present invention.

### DETAILED DESCRIPTION

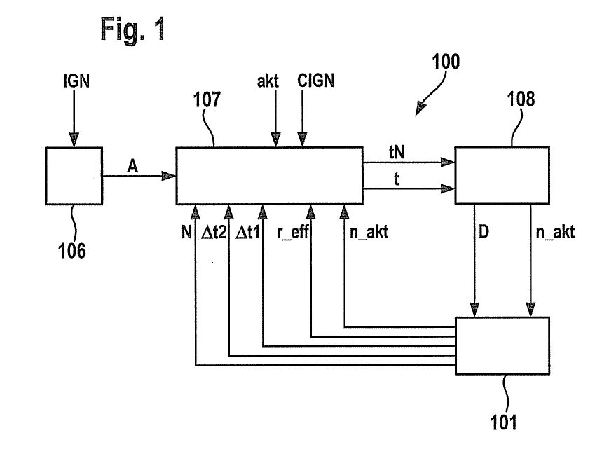

FIG. 1 depicts a controller 100 having a memory 101. The controller moreover encompasses an acquisition device 106, an identifying device 107, and a calculation device 108.

Acquisition device 106 acquires a signal IGN, which is sent e.g. from a switch (not depicted in FIG. 1) to controller 100 and represents a switching-off request, for example of a driver of a motor vehicle or of a user of an electronic device in which the controller is installed. Acquisition device 106 identifies from signal IGN a signal A. Signal IGN is, for example, a voltage signal that assumes the values 0.5 V and 4.5 V. Signal A is, for example, a digital signal that is saved in a RAM memory in controller 100 and assumes the values 0 and 1. For example, a signal A value=1 corresponds to a request to switch off controller 100. The value 0.5 V of signal IGN has associated with it, for example a value for signal A=1. A signal A value=0 is correspondingly associated with the value 4.5 V of signal IGN. The signal A value=0 means, for example, a request to operate controller 100.

Signal A is sent from acquisition device 106 to identifying device 107. Identifying device 107 furthermore receives a signal akt that, for example in a motor vehicle, is sent from an engine controller to controller 100 and indicates a current total mileage of the motor vehicle, in kilometers, since manufacture of the motor vehicle.

Identifying device 107 reads a first defined threshold value, for example an effective limit factor r_eff, as well as a number of write accesses n_akt, from memory 101. The number of write accesses n_akt is an accumulated value that represents the number of write accesses since manufacture of the controller.

For this purpose, the number of write accesses n_akt is increased by one at each write access to memory 101 and, together with data D from calculation device 108, saved in memory 101.

The first defined threshold value r_eff is calculated as a function of a maximum memory cycle count n_max and, for example, for a specific total vehicle mileage km_max specified by the vehicle manufacturer. The specified total vehicle mileage selected is, for example km_max=300,000 km. For a maximum memory cycle count n=100,000 specified by the manufacturer of memory 101, this yields a limit factor

r_{—}grenz=n_max/km_max=⅓ cycle per kilometer.

On average, therefore, no more than one memory operation every 3 km should occur in order to ensure reliable functioning of the controller during the entire specified total vehicle mileage.

The limit factor r_grenz yields the first defined threshold value r eff, either directly as

r_{—eff=r}_{—grenz}

or, in consideration of a factor F, as

r_{—}eff=r_{—}grenz*F.

Factor F here represents a safety reduction that is adapted, for example before initial service introduction of controller 101, to the needs of the user of controller 101. Factor F is therefore selected as, for example, 0.9.

The first defined threshold value r_eff is permanently saved in memory 101, for example, upon manufacture of the controller. In this case memory 101 is a nonvolatile memory. Alternatively, the first defined threshold value r_eff can also be saved in a different nonvolatile memory, or even after the manufacture of controller 101.

Identifying device 107 identifies a setpoint, which will also be referred to hereinafter as a defined time period tN. The invention is not limited to identification of the setpoint as a defined time period. The setpoint can instead also be any other variable that serves as a criterion, for purposes of example embodiments of the present invention, for determining a suitable point in time for saving. For example, the setpoint can also be a number of successive operating cycles, for example ignition cycles in the case of a motor vehicle.

According to example embodiments, the setpoint is first set to a second defined threshold value N that, for example, is read out of memory 101. The second defined threshold value N is determined, for example, as a function of how long the saving of data D in memory 101 is to be delayed in every case, for example so that a save action is not performed in the context of short interruptions in operation. The second defined threshold value N is set, for example, as 2 minutes, so that at least 2 minutes must elapse before a save operation is performed. The second defined threshold value N is selected, for example, as zero in order always to save the data m immediately after the switch-off request. The second defined threshold value N is saved in memory 101 upon manufacture of the controller 100.

Identifying device 107 furthermore identifies a frequency r_akt of write operations per operating unit of controller 100. The operating unit of controller 100 is, for example, the current total mileage. The frequency r_akt of write operations per operating unit of controller 100 is calculated, for example, as a function of the current total mileage akt and the number of write accesses n_akt, e.g. as follows:

r_{—}akt =n_{—}akt/akt.

Identifying device 107 compares the frequency of write operations per operating unit r_akt of controller 100 with the first defined threshold value r_eff, and increases the setpoint, for example the defined time period tN, by a first defined value Δt1 if the frequency r_akt of write operations per operating unit of controller 100 is greater than the first defined threshold value r_eff. The first defined value Δt1 is, for example, read out of memory 101.

The first defined value Δt1 serves for successive lengthening of the defined time period tN, and is selected, for example, as 1 minute; it is likewise saved in memory 101 upon manufacture of the controller 100.

Identifying device 107 furthermore checks whether the defined time period tN is greater than the third defined value tNmax. The third defined value tNmax corresponds to a maximum lengthening of the defined time period tN, for example 15 minutes, which is determined so that, for example, a battery used to supply voltage to the controller is not excessively stressed when the controller is not being operated. The third defined value tNmax is, for example, saved in memory 101 upon manufacture of the controller, and read out of memory 101.

Identifying device 107 furthermore checks whether the defined time period tN is greater than the second defined threshold value N. The second defined threshold N here represents a waiting time that is to be observed in every case for any save frequency. The second defined threshold value N also prevents the setpoint from becoming arbitrarily small, for example less than zero. Identifying device 107 decreases the defined time period tN by a second defined value Δt2 as long as the defined time period tN is greater than the second defined threshold value N. The second defined value Δt2 is, for example, likewise selected as 1 minute, and is saved in memory 101 upon manufacture of the controller 100. Identifying device 107 then reads the second defined value Δt2 out of memory 101.

In the event the controller is installed in a motor vehicle, identifying device 107 furthermore reads an ignition cycle CIGN, which for example is determined in known fashion by an engine control system provided in the motor vehicle and is transmitted as an integer value in known fashion, for example via a CAN bus, to controller 100. The ignition cycle indicates, as an integer value greater than zero, how often the ignition of the motor vehicle has been actuated since manufacture of the motor vehicle.

Identifying unit 107 identifies, from the ignition cycle CIGN, a third threshold SIGN, for example as a function of how many ignition cycles need to elapse before another increase in the defined time period tN. For example, the third threshold is identified as a function of a fourth defined value Z, as follows:

SIGN=CIGN+Z.

The fourth defined value Z is set, for example, to 10.

Identifying unit 107 checks whether the ignition cycle CIGN is greater than the third threshold SIGN, and increases the defined time period tN by the first defined value Δt1 only when the ignition cycle CIGN is greater than the third threshold SIGN.

Identifying unit 107 receives signal A and starts a timer which is provided in identifying device 107 and outputs a time t. For this purpose, the timer is started, for example, at a rising edge of signal A, i.e. as soon as the value of signal A changes from zero to one.

Calculation device 108 receives the time t and the defined time period tN from identifying device 107. Calculation device 108 checks whether time t that has elapsed since the acquisition of a switch-off request A exceeds the defined time period tN. As soon as time t exceeds the defined time period tN, data D from calculation device 108 are saved in memory 101.

At the same time, the number of write accesses n_akt is in addition increased by one by calculation device 108, and also saved in memory 101. Calculation device 108 then, in known fashion, triggers shutoff of controller 100.

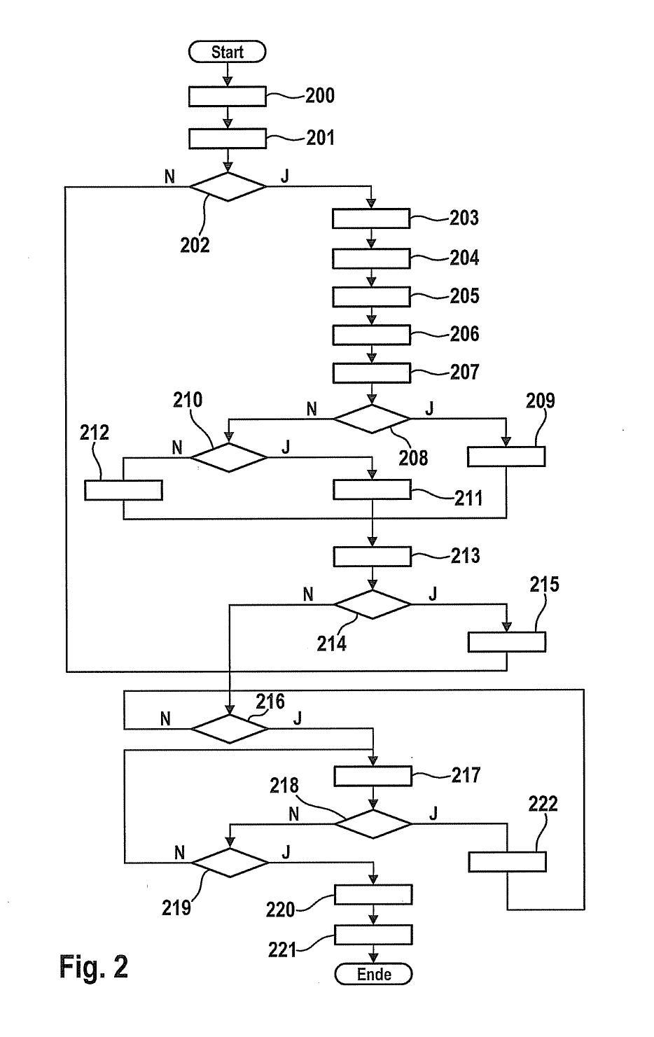

The method according to example embodiments of the present invention will be explained below with reference to the flow chart of FIG. 2. Prior to the start of the method, upon an initialization of memory 101 e.g. during the manufacture of controller 100, the value for the number of write accesses n_akt in memory 101 is set to 0. The method is then started each time controller 100 is started. The method then continues with a step 200.

In step 200 the second defined threshold value N is read out of memory 101 and the defined time period tN is set to be equal to the second defined threshold value N. In addition, a change in the defined time period ΔtN is set to zero. In addition, the third threshold value SIGN is set to the fourth defined value Z. The third threshold value SIGN, the defined time period tN, and the change in the defined time period ΔtN are stored, for example, as variables in a RAM in controller 100. The method then continues in a step 201.

In step 201, the ignition cycle CIGN is read, for example from the CAN bus, as an integer value. The method then continues in a step 202.

Step 202 checks whether the ignition cycle CIGN is greater than the third threshold value SIGN. If the ignition cycle CIGN is greater than the third threshold value SIGN, execution branches to a step 203; if not, to a step 216.

In step 203, the third threshold value SIGN is identified as a function of the ignition cycle CIGN and the fourth defined value Z. For example, the third threshold value is identified as follows:

SIGN=CIGN+Z.

The method then continues in a step 204.

In step 204 the number of write accesses n_akt that has already occurred since manufacture of the controller is read out, for example, from memory 101. The method then continues in a step 205.

In step 205 the current total vehicle mileage akt is read out, for example, from the CAN bus. The method then continues in a step 206.

In step 206 the frequency r_akt of write operations per operating unit of controller 100 is identified. The frequency r_akt is identified, for example, as a function of the number of write accesses n_akt and the current total mileage akt, as follows:

r_{—}akt=n_{—}akt/akt.

The method then continues in a step 207.

In step 207 the first defined threshold value r_eff constituting the effective limit factor is read, for example, out of memory 101. The method then continues in a step 208.

Step 208 checks whether the frequency r_akt is greater than the first defined threshold value r_eff. If the frequency r_akt is greater than the first defined threshold value r_eff, execution branches to a step 209; if not, to a step 210.

In step 209 the first defined value Δt1 is read out from memory 101, and the change in the defined time period ΔtN is set to be equal to the first defined value Δt1, for example equal to 1 minute. The method then continues in a step 213.

Step 210 checks whether the defined time period tN is greater than the second defined threshold value N. If Yes, execution branches to a step 211; if No, to a step 212.

In step 211 the second defined value Δt2 is read out from memory 201, and the change in the defined time period ΔtN is set to be equal to the second defined value Δt2, for example equal to −1 minute. The method then continues in step 213.

In step 212 the change in the defined time period Δtn is set to be equal to 0. The method then continues in step 213.

In step 213 the defined time period tN is identified as a function of the change in the holdover time ΔtN. The defined time period tN is, for example, calculated as follows:

tN=tN+ΔtN.

The method then continues in a step 214.

Step 214 checks whether the defined time period tN is greater than the third defined value tNmax, for example 15 minutes. If Yes, execution branches to a step 215; otherwise to a step 216.

In step 215 the defined time period tN is set to be equal to the third defined value tNmax. The method then continues in step 216.

Step 216 checks whether signal A has a positive edge. If signal A has a positive edge, execution branches to a step 217; if not, to step 216.

In step 217 the timer is started, or continues to operate if the timer is already running. The method then continues in step 218.

Step 218 checks whether signal A has a negative edge. If signal A has a negative edge, execution branches to a step 222; if not, to step 219.

Step 219 checks whether time t is greater than the defined time period tN. If time t is greater than the defined time period tN, execution branches to a step 220; if not, to step 217.

In step 220 the number of write accesses n_akt is increased by one, the timer is stopped, and time t is set to a value of zero. The method then continues in a step 221.

In step 221 the data D and the number of write accesses n_akt are saved in memory 101. The controller is then switched off and the method ends.

In step 222 the timer is stopped and time t is set to a value of zero. The method then continues in step 216.

In example embodiments, signal akt is calculating using a current number of operating hours, instead of the total mileage of the motor vehicle. This means that the operating unit of controller 100 in this case is the number of operating hours. Alternatively, the number of switch-on or switch-off operations, or operating cycles, of controller 100 can be used as the operating unit of controller 100. This allows the method according to example embodiments of the present invention also to be applied generally to electronic devices. For this, the switch-off request is acquired, for example, by way of a switching signal that is sent to controller 100 from an on/off switch of the electronic device. The comparison result is calculated in accordance with the above-described example embodiment, an internal counter that counts the operating cycles of the electrical device now being used instead of the ignition cycle CIGN. The steps of the method are executed in accordance with the above-described example embodiment.

In a modification of the example embodiments described above, steps 202, 203, and 204 for evaluation of the ignition cycle CIGN or of the operating cycle can be omitted in order to simplify the configuration. In this case step 205 (instead of step 202) is executed directly after step 201.

The method is preferably executed as a computer program on controller 100. For this purpose, the computer program is stored, for example, on a computer program product and transferred into memory 101 upon manufacture of controller 100.

1-12. (canceled)

13. A method for operating a controller to save data in a memory after sensing of a switch-off request, comprising:
defining a setpoint for a time period over which the controller is to be left switched on in extended fashion;
identifying an actual value corresponding to a time that has elapsed after sensing of the switch-off request;
comparing the actual value with the setpoint;
saving the data as soon as the actual value exceeds the setpoint.

14. The method according to claim 13, further comprising correcting the setpoint as a function of a frequency of write operations per operating unit of the controller.

15. The method according to claim 14, further comprising:
defining a first threshold value;
indentifying the frequency;
comparing the frequency with the first defined threshold value; and
increasing the setpoint by a first defined value if the frequency is greater than the first defined threshold value.

16. The method according to claim 14, further comprising:
defining a first threshold value;
identifying the frequency;
comprising the frequency with the first threshold value′ and
decreasing the setpoint by a second defined value if the frequency is less than the first threshold value.

17. The method according to claim 16, further comprising:
defining a second threshold value;
checking whether the setpoint is greater than the second threshold value; and
decreasing the setpoint by the second defined value as long as the setpoint is greater than the second threshold value.

18. The method according to claim 14, wherein the frequency is identified as a function of at least one of (a) a current total mileage of a motor vehicle and (b) a current number of operating hours of the controller and of a number of write accesses to the memory.

19. The method according to claim 17, further comprising defining a third value is defined, wherein the setpoint does not exceed the third defined value.

20. The method according to claim 13, wherein the controller is switched off as soon as the data has been saved.

21. A controller, comprising:
a memory adapted to store data;
an identification device adapted to define a setpoint for a time period over which the controller is to be left switched on in extended fashion, the identification device adapted to identify an actual value corresponding to a time that has elapsed after sensing of the switch-off request;
a calculation device adapted to compare the actual value with the setpoint and to save the data as soon as the actual value exceeds the setpoint.

22. The controller according to claim 21, wherein the controller is adapted to perform the method recited in claim 13.

23. A non-transitory computer-readable storage medium with an executable program stored thereon, wherein the program instructs a microprocessor to perform a method as recited in claim 13.
